(19) United States
(12) Patent Application Publication
(10) Pub. No.: US 2009/0198744 A1
(43) Pub. Date: Aug. 6, 2009

(54) ELECTRONIC FILE MANAGING APPARATUS AND ELECTRONIC FILE MANAGING METHOD

(75) Inventor: Yasufumi NAKAMURA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/364,755

(22) Filed: Feb. 3, 2009

(30) Foreign Application Priority Data
Feb. 4, 2008 (JP) 2008-024441

(51) Int. Cl. G06F 17/30

(52) U.S. Cl. 707/201; 707/E17.01

(57) ABSTRACT

An electronic file managing apparatus and an electronic file managing method, which are intended to manage electronic files in units of conceptual folders and to facilitate the visual recognition of management status, are provided. The electronic file managing apparatus for managing files or folders includes a file change detecting unit for detecting that a file or folder is copied to a location manageable by the electronic file managing apparatus, and that the copied file or folder is changed, and a virtual folder managing unit for managing the copied or changed file or folder and a copy or change source file or folder as virtual folders by making an association between the copied file or folder and the copy or change source file or folder.

### BACKGROUND OF THE INVENTION

1. Field of the Invention

The present invention relates to a technique for managing electronic files, and more particularly, to an electronic file managing apparatus and an electronic file managing method, which are intended to graphically represent the management status of electronic files.

2. Description of the Related Art

In recent years, it has become common that individuals or enterprises possess and use a plurality of personal computers as the prices of information devices are reduced. When data is shared by a plurality of personal computers, a network is configured, and the data is used by being copied depending on need to many file servers on the network, and various data storage media such as a PDA, a USB memory, a hard disk, a CF card, an SD card, a memory stick, a floppy disk, an MO, an MD, a CD-R/RW, a DVD-R/-RW/+R/+RW/RAM, etc.

Additionally, data is shared usually by being read/written from/to a storage region of one personal computer by another personal computer, or by installing a file server or an NAS (Network-Attached Storage: an external storage device assumed to be used on a network), which is dedicated to file sharing.

Also a service called network storage is available on the Internet, and an environment where data can be shared at any time via the Internet by paying a predetermined usage fee is established.

Furthermore, various storage media such as a USB memory, a USB hard disk, a CD-RW, a DVD-RAM, etc. have been widely used as external storage media according to lower prices, higher densities and smaller sizes of external storage devices and storage media.

In such a situation, identical files are apt to scatter in a plurality of devices and media. Moreover, identical files are redundantly stored in different drives or different folders even in the same device or medium in some cases.

Therefore, a user is forced to take a lot of time to search many similar files for his or her required file, and to examine the latest file. If such a situation where many similar files scatter occurs, it takes enormous amounts of time and labor to organize the files, leading to a heavy burden.

In the meantime, it is recommended to often back up a file when it is created or edited. This is because a file including important data accidentally becomes unrestorable if it is edited by being overwritten, or the data can possibly be lost due to the sudden freeze of an operating device such as a personal computer, etc., or due to blackout.

There are devices for sequentially backing up a file to an external storage device each time a created/edited file is updated as an auxiliary device for backing up such a file being edited. For example, a device called a MEDIA TANK sequentially backs up a file by performing an operation for sequentially backing up a changed file to the hard disk within the media tank, which is connected via a network, if a file is changed within a pre-specified folder.

Additionally, a usual method is executed as follows: an original file is copied, the file copy is edited, and the original file is overwritten with the edited file copy if the file copy is successfully edited. Moreover, even while the file copy is being edited, operations are advanced in many cases by often backing up the file being edited as an alias file if the file being edited is changed a lot.

Such temporary files can be deleted upon completion of editing. However, also files being edited remain for a while, for example, if a comparison is made between files, which are generated from one original document and edited in two patterns.

Judging from the above described situations, it can be said that a recommended environment for information processing is an environment where a file can be shared with ease and is often backed up.

Furthermore, the consciousness of users using information processing devices has been changing as the capacities of disks are being increased and the prices of media are being reduced by the recent technological advances. Namely, users fear the loss of information that can possibly be required later rather than spare the labor for saving the capacity of a disk. Because of such a fear, users copy a file more than necessary, and leave the file copy even if it becomes unnecessary. This is the redundancy or the duplication of information. Conversely, however, it is a recommended action when data must be restored in case of emergency. Namely, even when an original file disappears, the original information can be restored with high possibility if many copies are left.

However, such an environment poses a problem that a target file cannot be found with ease when a user attempts to reuse a previously used file.

Additionally, since identical files scatter in a plurality of devices and media, the latest version cannot be learned quickly.

There is also a problem such that an operation for identifying a target file when a plurality of candidate files are found becomes complicated. This requires more cost to search for required information than conventional.

Accordingly, Patent Document 1 discloses the technique for reducing the risk of losing a file, and for enabling the amount of time required to detect an entirely or partially redundant file to be shorter than at least that required with a round-robin method. If redundant data exists, it can be always saved in a storage region with high reliability. This can reduce the risk of losing data. Moreover, the process for detecting redundant files can be made shorter than that for detecting redundant files with a round-robin method. As a result, efficient file management can be made.

Patent Document 2 proposes the system for maintaining a file copy and an original file in the latest state. Since all of edited files can be saved in synchronization, data can be easily restored from one file even if the other file is lost.

Patent Document 3 proposes the technique for enabling a previously used file to be easily grasped. Namely, when a file is operated, its operation history is managed.

Patent Document 1 proposes the detection of redundant files in units of files. With this technique, files detected to be redundant are listed in units of files. This display method is effective if the number of files is small. However, for example, if several thousands of files are copied to a plurality of storage regions in units of folders, the list of redundant files results in several thousand rows, which is difficult to be checked with human eyes.

Additionally, an operation for verifying an operation status by creating setups modified with a plurality of patterns in order to check an operation is often performed in a development scene. In this case, a plurality of file groups of different versions exist. Moreover, the file groups are stored in a file server on a network in many cases since many people check an operation. As described above, the redundancy of individual files can be displayed with the system disclosed by Patent Document 1 in a development scene, but the latest file cannot be easily learned.

Patent Document 2 recites the technique for always synchronizing a file to the latest state. This is helpful if a file is accidentally lost. However, for example, if a file is erroneously edited, it is synchronized to incorrect contents. Therefore, the file cannot be restored to the state before being synchronized. To avoid such a problem, a file must be backed up over two generations or more. However, Patent Document 2 does not refer to the generation back-up.

Patent Document 3 recites the technique for increasing an editing efficiency. However, Patent Document 3 does not refer to back-up at the time of editing. Additionally, this technique requires another computer for managing an editing history, which requires a large-scale system to be built.

Patent Document 1: Japanese Patent Publication No. 2006-338461

Patent Document 2: Japanese Patent Publication No. 2002-268931

Patent Document 3: Japanese Patent Publication No. 2002-140216

### SUMMARY OF THE INVENTION

The present invention was developed in light of the above described circumstances, and an object thereof is to provide an electronic file managing apparatus and an electronic file managing method, which are intended to manage electronic files in units of conceptual folders and to facilitate the visual recognition of management status.

An electronic file managing apparatus for managing files or folders in one aspect of the present invention detects that a file or folder is copied to a location manageable by the electronic file managing apparatus, and that the copied file or folder is changed. Additionally, the electronic file managing apparatus manages the copied or changed file or folder and a copy or change source file or folder as virtual folders by making an association between them.

With the above described configuration, the copied or changed file or folder is managed in units of conceptual folders, and the visual recognition of management status is facilitated. Additionally, files or folders can be managed even if an editing operation such as a copy, a deletion, a rename operation, etc. is performed for a file or folder.

The disclosed apparatus and method manage electronic files in units of conceptual folders, and facilitate the visual recognition of management status. Additionally, files or folders can be managed even if an editing operation such as a copy, a deletion, a rename operation, etc. is performed for a file or folder.

### BRIEF DESCRIPTION OF THE DRAWINGS

FIG. 1 is a block diagram showing a configuration of an electronic file managing apparatus;

FIG. 2 is a diagram showing one example of a virtual folder graph;

FIG. 3 is a diagram showing an example of data records of management information;

FIG. 4 is a flowchart showing a process executed when a virtual folder is generated;

FIG. 5 is a flowchart showing a process executed when a virtual folder is changed;

FIG. 6 is a flowchart showing an operation performed to a removable external storage device;

FIG. 7 is a flowchart showing a process executed when an internal folder is searched;

FIG. 8 is a flowchart showing a process executed when a similar folder is searched;

FIG. 9 is a flowchart showing a process executed when an external storage device is connected;

FIG. 10 is a flowchart showing an external storage search process;

FIG. 11 is a diagram showing a display screen when an application using the present invention is invoked;

FIG. 12A is a diagram showing an example of mapping and displaying virtual folders in an XY graph;

FIG. 12B is a schematic diagram showing an example of a case where the details of a difference are displayed; and

FIG. 13 is a block diagram showing a system configuration for carrying out the present invention.

### DESCRIPTION OF THE PREFERRED EMBODIMENTS

### First Embodiment

An embodiment according to the present invention is described in detail below with reference to the drawings.

(Configuration)

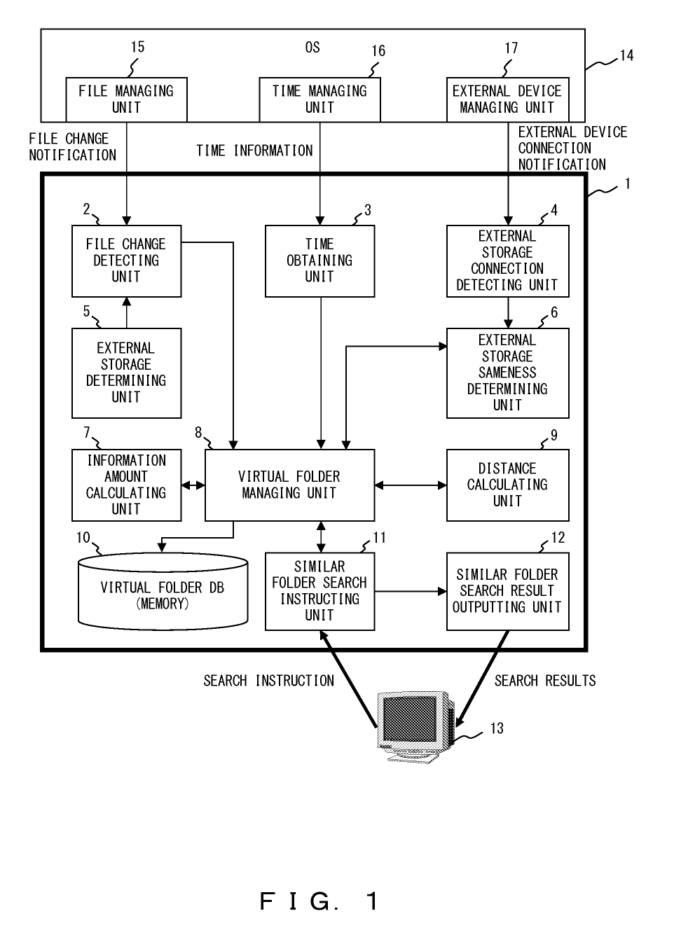

FIG. 1 is a block diagram showing a configuration of a system for managing electronic files.

An electronic file managing apparatus 1 is configured with a file change detecting unit 2, a time obtaining unit 3, an external storage connection detecting unit 4, an external storage determining unit 5, an external storage sameness determining unit 6, an information amount calculating unit 7, a virtual folder managing unit 8, a distance calculating unit 9, a virtual folder database 10, a similar folder search instructing unit 11, and a similar folder search result outputting unit 12. The electronic file managing apparatus 1 obtains a file change notification, time information, and an external device connection notification respectively from a file managing unit 15, a time managing unit 16, and an external device managing unit 19 of an operating system 14.

The file change detecting unit 2 obtains the file change notification transmitted from the file managing unit 15, and external storage information notified from the external storage determining unit 5. The file change detecting unit 2 detects, based on the obtained file change notification and external storage information, that a folder or file is changed, and notifies the virtual folder managing unit 8.

The time obtaining unit 3 obtains the time information notified from the time managing unit 16, and transfers the obtained time information to the virtual folder managing unit 8.

The external storage connection detecting unit 4 detects that an external storage device is connected by obtaining the external device connection notification, which notifies that the external storage device is connected, from the external device managing unit 17, and notifies the external storage sameness determining unit 6.

The external storage determining unit 5 determines whether or not a changed file is a file recorded in a removable external storage device. The external storage determining unit 5 sets a flag indicating whether or not a copied file is a file copied to a removable external storage device, when the file is copied.

The external storage sameness determining unit 6 determines whether or not a file or folder recorded in an external storage device is already managed.

The information amount calculating unit 7 calculates, for example, the total of the numbers of bits of files, the number of folders, or the like within a virtual folder to be described later, and transfers the calculated total, the number, or the like to the virtual folder managing unit 8.

The information amount may be calculated based on the bit rate of a video image file within the virtual folder, based on the screen resolution of a video image file within the virtual folder, or based on the bit rate of an audio file within the virtual folder.

Alternatively, the information amount may be calculated based on the sampling rate of an audio file within the virtual folder, or based on the image quality of a still image file within the virtual folder.

The virtual folder managing unit 8 controls the constituent elements that configure the electronic file managing apparatus 1, and transfers necessary data to the virtual folder database 10, etc.

The distance calculating unit 9 calculates, for example, a difference between the checksums of files within a change source folder and within a change destination folder, and transfers the result of the calculation to the virtual folder managing unit 8.

The virtual folder database 10 is a memory for recording management information of the virtual folder, which will be described later.

The similar folder search instructing unit 11 transfers an instruction notification to the virtual folder managing unit 8 when a user selects a start button displayed on a display unit 13 to search for a similar folder.

Then, the similar folder search result outputting unit 12 obtains the results of the similar folder search from the similar folder search instructing unit 11, and displays the results of the search on the screen of the display unit 13.

Additionally, the similar folder search result outputting unit 12 outputs the results of the similar folder search in descending order of the amount of information within a virtual folder, which is calculated by the information amount calculating unit 7.

The above described electronic file managing apparatus 1 may be carried out, for example, with a CPU or a programmable device.

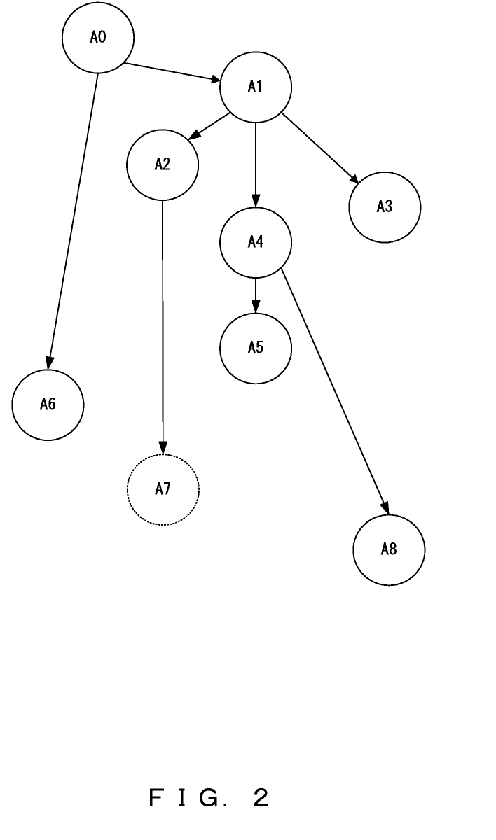

FIG. 2 is a diagram showing a relationship among folders generated based on one folder. This is a relationship among the folders that are generated by copying an original folder A0, and by changing or deleting some of files within a folder. The graph of this tree structure is hereinafter referred to as a “folder graph”.

For example, the folder A0 indicates the original folder. A folder A1 is assumed to be a folder that is newly generated by copying some files or folders within the folder A0.

A folder A2 is assumed to be a folder that is generated by copying the whole of the folder A1, and by editing and changing some of the files within the folder A1. A folder A3 is assumed to be a folder that is newly generated by copying some of the files or folders within the folder A1.

A folder A4 is assumed to be a folder that is generated by copying the whole of the folder A1. A folder A5 is assumed to be a folder that is generated by copying the whole of the folder A4. A folder A6 is assumed to be a folder that is generated by copying the whole of the folder A0, and by deleting some of the files within the folder A0.

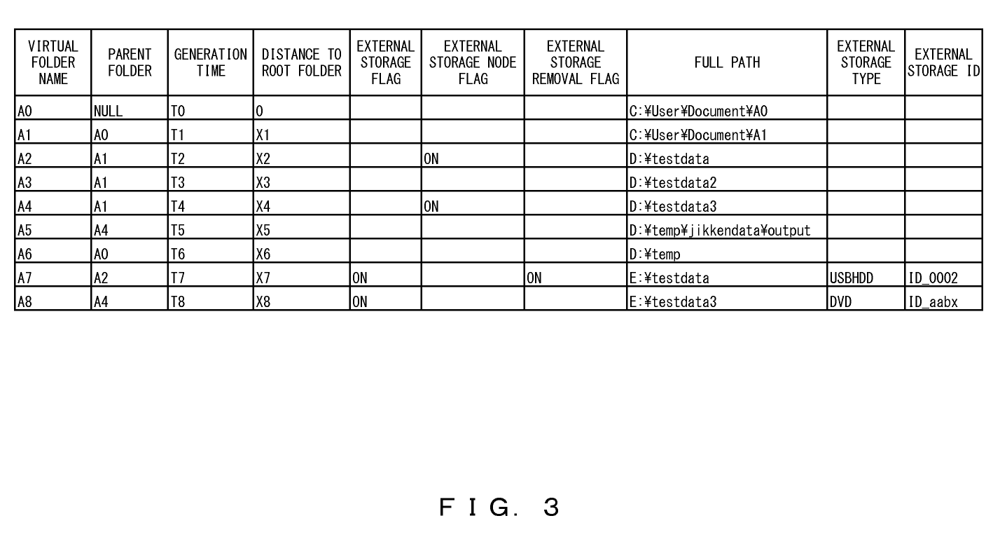

FIG. 3 is a diagram showing data records of management information used to manage files or folders when the folder graph shown in FIG. 2 or the like is generated.

Namely, the management information is used to handle, as one group, a relationship among an original file or folder and files or folders generated by changing the original file or folder.

If files or folders have the above described relationship of one group, they are hereinafter referred to as virtual folders.

The data records of the management information are respectively composed of, for example, a “virtual folder name” a “parent folder” a “generation time” a “distance to root folder” an “external storage flag” an “external storage node flag” an “external storage removal flag” a “full path” an “external storage type” an “external storage ID”; etc.

In the “virtual folder name” the name of an original file (root file) or an original folder (root folder), or the name of a file or folder generated by changing the root file or the root folder are recoded.

In the management information shown in FIG. 3, the folders A0 to A8 represented by the folder graph shown in FIG. 2 are recorded. This management information is recorded in the virtual folder database 10 (memory) shown in FIG. 1.

In the “parent folder” the name of a file or folder, from which a corresponding file or folder recorded in the “virtual folder name” is generated, is recorded. In FIG. 3, the root folder is recorded, for example, as “NULL”.

In the “generation time”, the date and time (T0 to T8) when a corresponding file or folder recorded in the “virtual folder name” is generated, is recorded. For the root file or root folder, the date and time when it is initially generated is recorded. For a copied file or folder, the date and time when a copied file or folder is initially generated is recorded.

Each of the virtual folders has time information about its generation time point. The time information is information required to arrange the folders in order of their generation times. FIG. 2 represents that the folders are generated in the order of A0 to A1 to . . . to A6.

In the “distance to root folder” a distance to the root folder is recorded. Here, the distance indicates distance information, and is a numeric value obtained, for example, based on a difference between files included in folder. The distance may be defined, for example, based on a difference between the total (checksum) of the sizes of files within the root folder and the number of files included in each folder generated by changing the root folder. The distance may be defined also based on a difference between the numbers of characters of character strings of file names. In FIG. 2, A0 is the root folder, and distances to A0 are recorded respectively for A1 to A6. In the “distance to root folder” of the root folder A0 in FIG. 3, “0” is recorded. By recording “0” in this way, also the root folder can be handled in a unified manner.

Alternatively, the distance may be defined by using not the checksum but a calculated number of bytes of files within a folder. The distance may be also defined by using the number of files, a generation date, or the like.

The distance may be also defined by combining the above described conditions. In this case, the column of the “distance to root folder” is added correspondingly to the checksum, the number of bytes, the number of files, etc., and data is recorded to each of the conditions. The distance to the root folder is recorded, for example, as “0”.

In the “external storage flag” whether or not a corresponding file or folder recorded in the “virtual folder name” is recorded in an external storage device is recorded. If the file or folder is recorded in the external storage device, the flag is validated. The flag may be set, for example, to “ON” as shown in FIG. 3.

In the “external storage node flag” a flag indicating a node of an internal folder, which connects to a virtual folder recorded in the external storage device, is recorded.

In the “external storage removal flag” whether or not an external storage device, in which a corresponding file or folder recorded in the “virtual folder name” is recorded, is connected is recorded. If such an external storage device is connected, the flag is validated. The flag may be set, for example, to “ON” as shown in FIG. 3.

In the “full path” a full path to a location, in which a corresponding file or folder recorded in the “virtual folder name” is recorded, is recorded.

In the “external storage type”, the type of an external storage device, in which a corresponding file or folder recorded in the “virtual folder name” is recorded, is recorded. In FIG. 3, “USBHDD” and “DVD” are recorded.

In the “external storage ID”, an ID for identifying an external storage device, in which a corresponding file or folder recorded in the “virtual folder name” is recorded, is recorded. In FIG. 3, “ID_{—}0002” and “ID_aabx” are recorded.

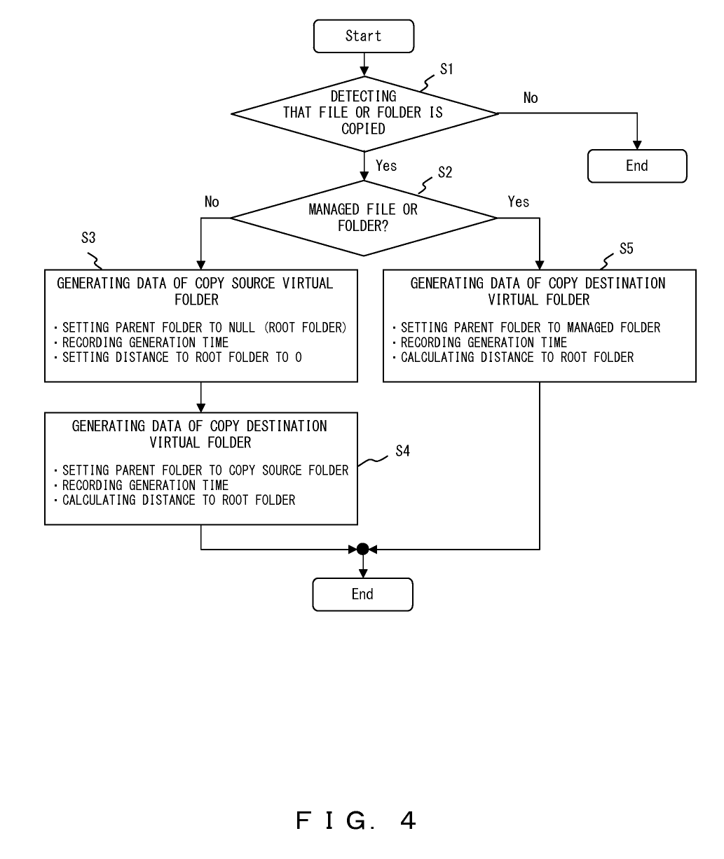

FIG. 4 is a flowchart showing a process for recording the generation of a virtual folder in the management information in order to handle a copied file or folder as one group.

In step S1, it is detected that a file or folder is copied within a system to be managed. If it is detected that the file or folder is copied, the process goes to step S2. If it is not detected that the file or folder is copied, the process is terminated.

Namely, in step S1, it is detected that the file or folder is copied, based on the file change notification transmitted from the file managing unit 15 to the file change detecting unit 2 shown in FIG. 1.

In step S2, whether or not the copied file or folder is an already managed file or folder is determined. If the copied file or folder is not an already managed file or folder, the process goes to step S3. If the file or folder copy is an already managed file or folder, the process goes to step S5.

The file change detecting unit 2 notifies the virtual folder managing unit 8 shown in FIG. 1 that the copied file or folder is an already managed file or folder.

Next, if the copied file or folder is a file or folder that is not managed yet by this system, such two folders as a copy source virtual folder and a copy destination virtual folder are generated as virtual folders. For example, in FIG. 2, A0 and A1 are simultaneously generated. At this time, the virtual folders are managed by being respectively assigned with one record as shown in FIG. 3. The copy destination virtual folder is managed as a child of the copy source virtual folder by using a tree structure. Specifically, the copy destination virtual folder may be managed with a list having pointer information to a parent folder.

In step S3, the copy source virtual folder, and the attribute data of the copy source virtual folder are generated. In the case of FIG. 2, the record of the root folder A0 is generated. Namely, the “parent folder” the “generation time”, and the “distance to root folder” which are shown in FIG. 3, are recorded. The virtual folder managing unit 8 shown in FIG. 1 records “NULL”, a generation time (T0), and “0” respectively in the “parent folder” the “generation time” and the “distance to root folder” in the virtual folder database 10 (memory).

In step S4, the attribute data of the copy destination virtual folder is generated. Namely, the copy source folder is set in the “parent folder” the copied time is recorded in the “generation time” and the distance to the root folder, which is calculated by the distance calculating unit 9, is recorded in the “distance to root folder”.

In step S5, the attribute data of the copy destination virtual folder is generated. Namely, the managed folder is recorded in the “parent folder” the copied time is recorded in the “generation time, and the distance to the root folder, which is calculated by the distance calculating unit 9, is recorded in the “distance to root folder”.

Namely, if a file or folder corresponding to a virtual folder managed by this system is copied, a child virtual folder is generated by using the virtual folder as a parent. In FIG. 2, A2 to A6 are child virtual folders. The parent of A2 to A4 is A1. The parent of A5 is A4. The parent of A6 is A0.

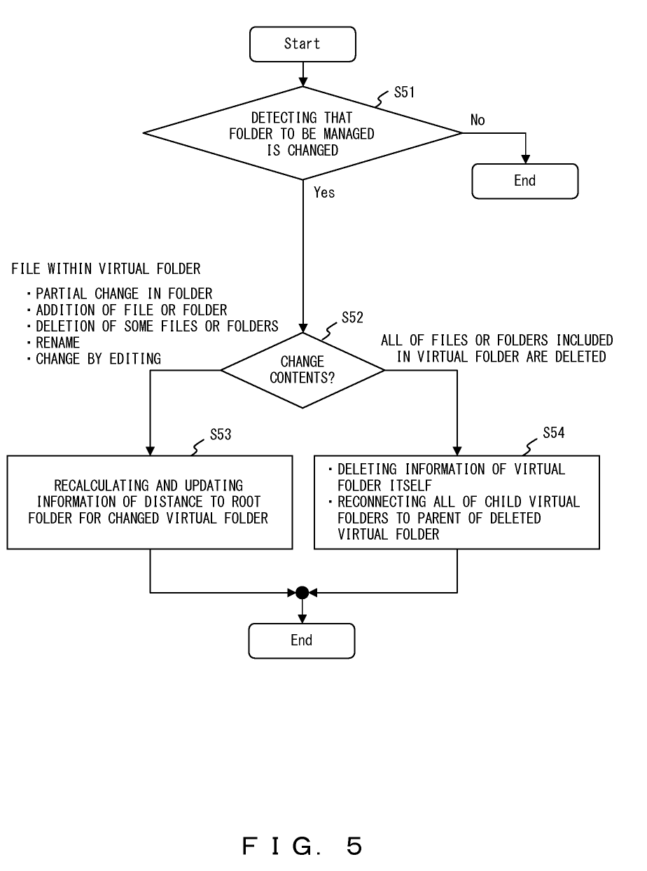

FIG. 5 is a flowchart showing a process executed when a virtual folder is changed.

In step S51, it is detected that a folder to be managed is changed. The file change detecting unit 2 detects the folder change based on the file change notification transmitted from the file managing unit 15 shown in FIG. 1.

In step S52, contents of the change are determined. If the contents are a partial change in a file or folder within the virtual folder, the process goes to step S53. The partial change is an addition of a file or a folder, deletion of some files or folders, rename, editing, etc. of a file or folder.

When files or folders are deleted, the process goes to step 54. Namely, this is the case where all of the files or folders included in the virtual folder are deleted.

In step S53, information about the distance to the root folder is recalculated and updated for the changed virtual folder.

In step S54, information of the virtual folder itself is deleted, and all of child virtual folders of the deleted virtual folder are reconnected to the parent of the deleted virtual folder, when all of the files or folders included in the virtual folder are deleted.

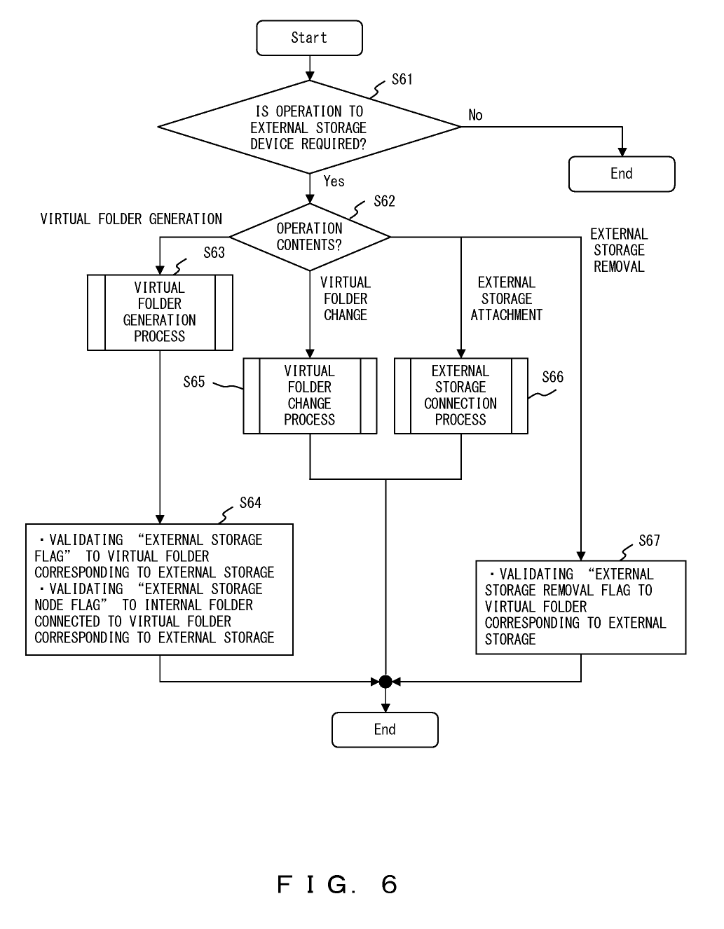

FIG. 6 is a flowchart showing an operation performed to a removable external storage device.

When a copy operation is performed to an external storage device (a USB memory, a file server on a network, etc.) removable from the system to be managed, the following special rules are set.

In step S61, whether or not there is an operation to the external storage device is determined. If there is the operation to the external storage device, the process goes to step S62. If there is not the operation to the external storage device, the process is terminated.

The external storage connection detecting unit 4 shown in FIG. 1 obtains the external device connection notification from the external device managing unit 17, and notifies the external storage sameness determining unit 6 of the connection state of the external storage device.

In step S62, contents of the operation are determined. If the operation is the generation of a virtual folder, the process goes to step S63. If the operation is a change in a virtual folder, the process goes to step S65. If the operation is the attachment of the external storage device, the process goes to step S66. If the operation is the removal of the external storage device, the process goes to step S67.

In step S63, the virtual folder generation process (the process shown in FIG. 4) is executed.

In step S64, an “external storage flag” that indicates an external storage device is set for a virtual folder corresponding to the external storage device.

Additionally, for a virtual folder in a storage region (internal folder), which is connected to a virtual folder corresponding to a removable external storage device in a folder graph and not removable from the system, an “external storage node flag” indicating a node of the folder recorded in the external storage device is set.

In step S65, the virtual folder change process (the process shown in FIG. 5) is executed.

In step S66, an external storage connection process to be described later is executed.

In step S67, an “external storage removal flag” indicating that the external storage device is removed is set for the virtual folder corresponding to the external storage device, if it is detected that the external storage device is removed.

For a virtual folder with its “external storage removal flag” set to ON, a process executed when a similar folder is searched, which will be described later, is not executed.

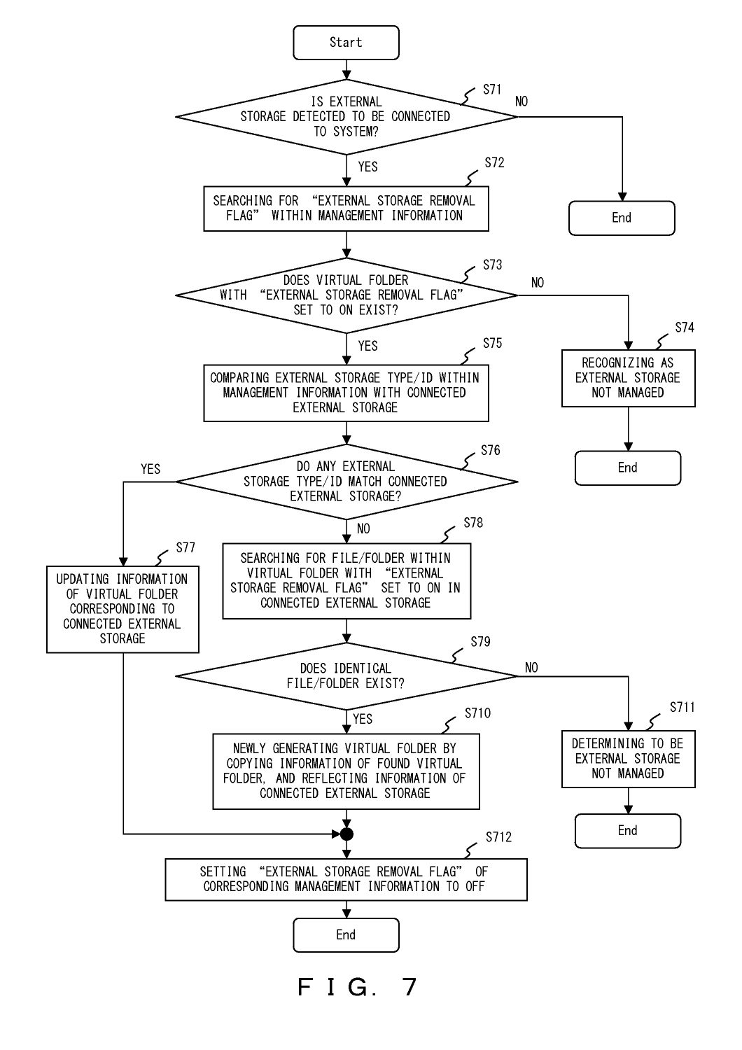

FIG. 7 is a flowchart showing a process executed when an external storage device is connected.

In step S71, whether or not an external storage device is connected to the system is detected. If the external storage device is detected to be connected, the process goes to step S72. If the external storage device is not detected to be connected, the process is terminated.

When an external storage device is connected to a personal computer into which this system is introduced, for example, when a USB memory or an HDD is connected by being inserted in the personal computer, an OS automatically recognizes this connection with a plug-and-play function. With this function of the OS, the connection of a USB device can be detected.

When a CD/DVD is inserted in a CD/DVD drive, an auto-run function of the OS starts to run, and the OS can detect the insertion of the CD/DVD. The OS can detect that a file server or an NAS on a network is connected to the network, when the file server or the NAS is logged in.

In step S72, the “external storage removal flag” within the management information is searched.

To determine whether or not a connected external storage device was previously managed by this system, the “external storage removal flag” is searched in the management information within this system.

In step S73, whether or not a virtual folder with its “external storage removal flag” set to ON exists is determined. If such a virtual folder exists, the process goes to step S75. Otherwise, the process goes to step S74.

If the “external storage removal flag” is not found in the management information, the connected storage device is definitely determined to be an external device that is not managed by this system.

In step S75, the “external storage type” and the “external storage ID” within the management information are compared with the connected external storage device. If the “external storage type” of the connected external storage device is, for example, a USB memory, a CD/DVD, or a file server or an NAS on the network, it can be identified respectively with a device ID, disk information, or a computer name.

In step S76, it is determined whether or not any “external storage type” and “external storage ID” within the management information match the connected external storage device. If a match is found, the process goes to step S77. Otherwise, the process goes to step S78.

In step S77, information of the virtual folder corresponding to the connected external storage device is updated. If the “external storage type” and the “external storage ID” within the management information match the connected external storage device, this device is determined to be an external device that was previously managed by this system. Then, the current state of the external storage device is reflected on the information within the management information (information about the full path, etc., distance information, and the like).

In step S78, a file or folder within a virtual folder with its “external storage removal flag” set to ON is searched in the connected external storage device.

If no matching file or folder exists, the connected external storage device can be definitely determined to be an external storage device that is not managed by the system.

In step S79, an identical file or folder or a partially identical file or folder is searched. If such a file or folder is found, the process goes to step S710. Otherwise, the process goes to step S711.

In step S710, a virtual folder is newly generated by copying the information of the found virtual folder, and the information of the connected external storage is reflected. If an identical file or folder or a partially identical file or folder found, the connected external storage device is determined to be possibly managed previously by this system.

In step S711, the connected external storage device is determined to be an external storage device that is not managed by this system.

In step S712, if the connected external storage device can be determined to be an external storage device that is managed by this system, the “external storage removal flag” of the corresponding management information is set to “OFF”. Thereafter, the virtual folder is similarly handled as an internal folder.

If the connected external storage device is determined to be previously managed by the system, the virtual folder within the management information is not changed. And a virtual folder is generated by copying the information of the virtual folder, and managed by the system. This is because it becomes impossible to cope with an actual external storage device when it is connected later, once the information within the management information is rewritten.

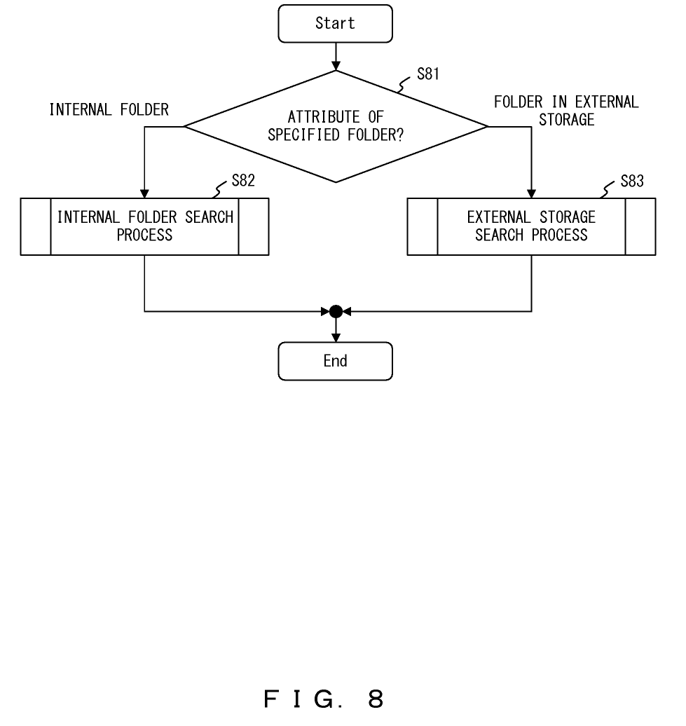

FIG. 8 is a flowchart showing a process executed when similar folder is searched.

In step S81, the attribute of a specified folder is determined. Depending on the attribute, the process goes to step S82, in which an internal folder search process is executed, or the process goes to step S83, in which an external storage search process for searching for a folder in an external storage device is executed. Here, the attribute is assumed to be the external storage flag of the management information shown in FIG. 3.

For example, when a user selects a similar folder search button displayed on the screen of the display unit 13 shown in FIG. 1, a search instruction notification is transferred to the similar folder search instructing unit 11.

Next, the process in step S82 or S83 is executed by the similar folder search instructing unit 11 or the similar folder search result outputting unit 12, and the results of the search are displayed on the display unit 13. The process in step S82 or S83 may be executed by the virtual folder managing unit 8.

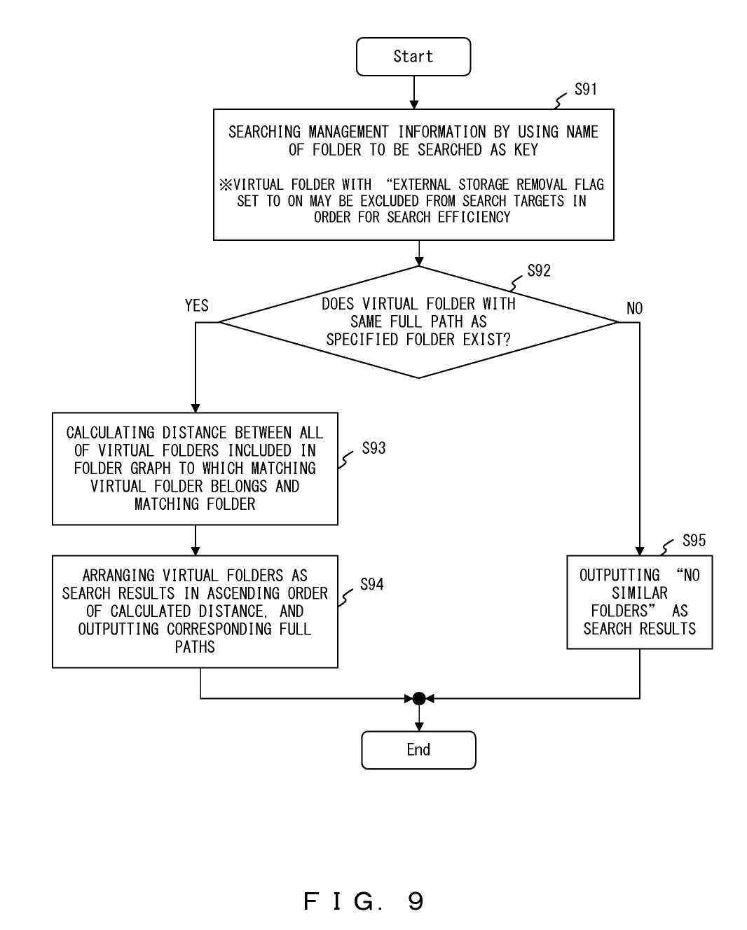

In step S82, the internal folder search process (the process shown in FIG. 9) is executed.

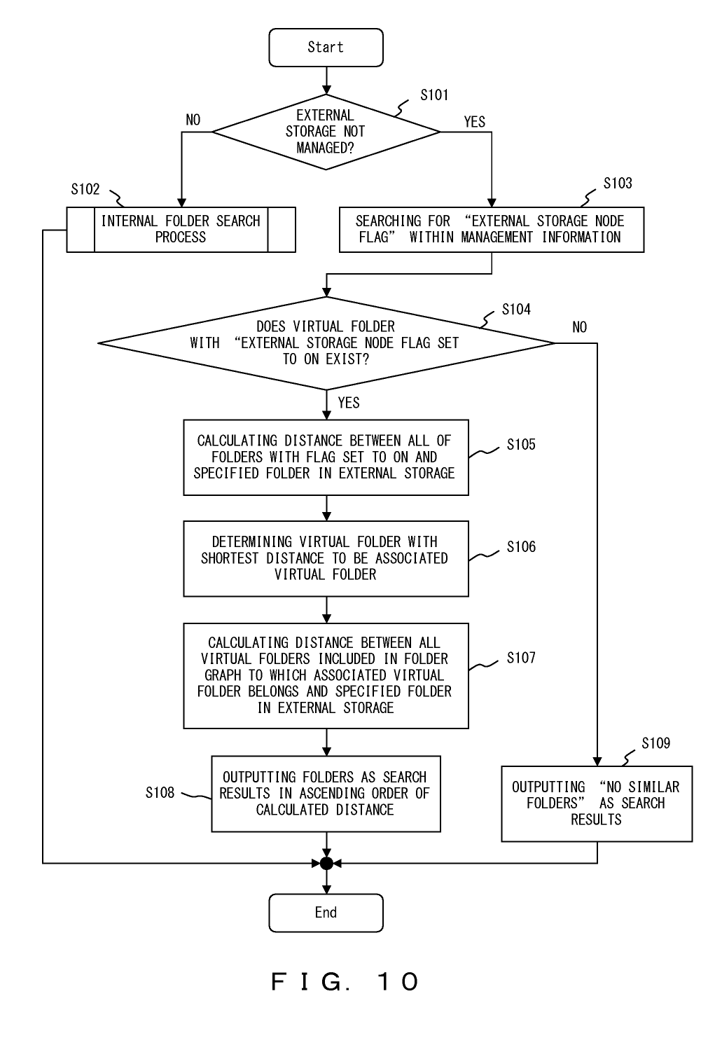

In step S83, the external storage search process (the process shown in FIG. 10) is executed.

Thereafter, a search result notification resultant from the process in step S82 or S83 is transferred from the similar folder search result outputting unit 12 to the display unit 13. Then, similar folders are displayed on the screen of the display unit 13.

Procedures for searching for a folder similar to a specified folder in the above described data structure are described next.

FIG. 9 is a flowchart showing the internal folder search process (in the case where an internal folder is specified).

In step S91, a search is made in the management information by using the name of a folder to be searched as a key. Here, a virtual folder with its “external storage removal flag set to ON may be excluded from search targets in order to increase search efficiency. Since all of internal folders are managed, a search is made in the management information by using the name of the folder to be searched as a key.

In step S92, whether or not a virtual folder with the same full path as that of the specified folder exists is determined. If such a virtual folder exists, the process goes to step S93. Otherwise, the process goes to step S95. Within the management information shown in FIG. 3, also the full paths of folders included in each virtual folder are recorded. Therefore, whether or not the full path of the specified folder matches any of the recorded full paths may be detected.

Considering the generation rules of a virtual folder, each full path is unique for a plurality of virtual folders. Therefore, only one matching virtual folder is found or no matching virtual folders are found.

In step S93, distances between all of included virtual folders and the root folder within the folder graph including the virtual folder having the matching full path are calculated.

In step S94, the virtual folders as search results are arranged in ascending order of the calculated distances, and their corresponding full path names are output. The search results transferred from the similar folder search result outputting unit 12 shown in FIG. 1 are displayed on the screen of the display unit 13.

If the matching virtual folder is the root folder, distances are already recorded in the management information. Therefore, it is not necessary to calculate the distances.

In step S95, the search results are output. The search results are transferred from the similar folder search result outputting unit 12 to the display unit 13, which in turn makes a display such as “no similar folders”.

If no matching virtual folders are found, this indicates that there are no similar folders in consideration of the mechanism of this system. Therefore, the process is terminated by determining that there are no similar folders.

FIG. 10 is a flowchart showing an external storage search process executed when a folder recorded in a removable external storage device is specified.

Initially, whether or not a connected external storage device was previously managed by this system is determined by executing the following process at the time point when the external storage device is connected to the system. If the connected external storage device is determined to be previously managed by the system, similar folders can be searched with the same procedures as the above described procedures in the above described case where an “internal folder” is specified.

In step S101, whether or not the connected external storage device is an external storage device that is not managed by the system is determined. If the connected external storage is an external storage device that is managed by the system, the process goes to step S102. If the connected external storage device is not an external storage device that is managed by the system, the process goes to step S103. Then, virtual folders with their “external storage node flag” set to ON in the management information are listed.

In step S102, the internal folder search process (the process shown in FIG. 9) is executed.

In step S103, the “external storage node flag” within the management information is searched.

In step S104, whether or not a virtual folder with its “external storage node flag” set to ON exists is determined. If such a virtual folder does not exist, the process goes to step S109. Otherwise, the process goes to step S105.

In step S105, in all of folders with their flag set to ON, distances between each folder and the specified folder recorded in the external storage device are calculated.

In step S106, the virtual folder with the shortest distance is determined to be an associated virtual folder.

In step S107, distances between all of the virtual folders included in the folder graph to which the associated virtual folder belongs and the specified folder recorded in the external storage device are calculated.

In step S108, the virtual folders as search results are output in ascending order of the calculated distances. The search results transferred from the similar folder search result outputting unit 12 shown in FIG. 1 are displayed on the screen of the display unit 13.

In step S109, a message such as “no similar folders” is output as the search results. The search results are transferred from the similar folder search result outputting unit 12 to the display unit 13, which in turn makes a display such as “no similar folders”.

Also for folders recorded in an external storage device that was not previously managed by this system, a similar folder search can be efficiently made with the following procedures.

### Second Embodiment

A method for displaying the degree of association among a plurality of associated folders in order to allow a user to intuitively learn is described.

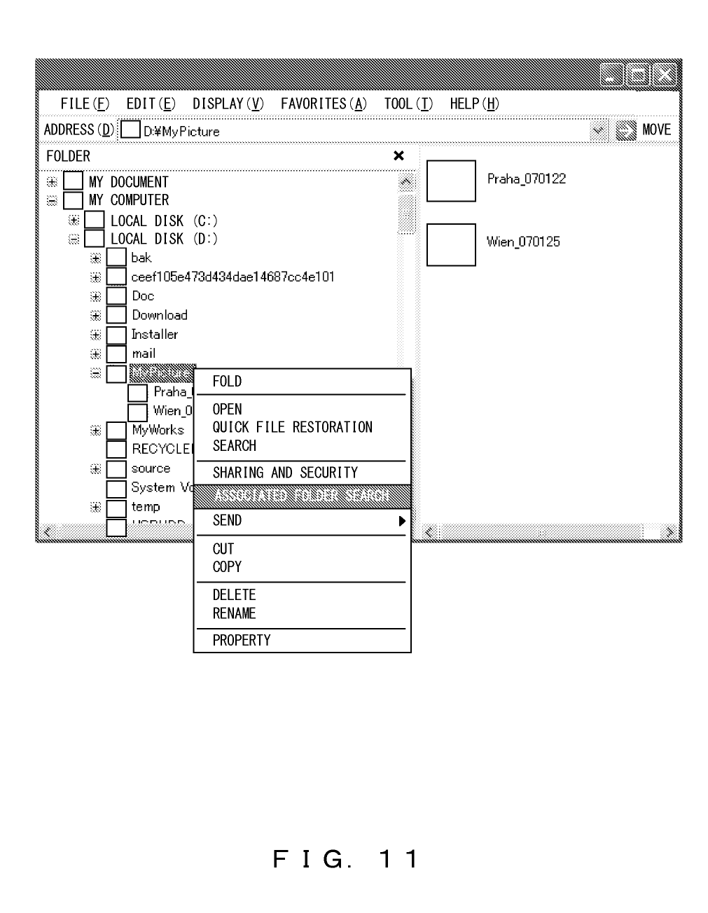

Initially, a folder the degree of association of which is desired to be examined is selected. Here, an example of a search using an add-in is shown in FIG. 11. An add-in for adding an entry of “associated folder search” in a menu when a folder is selected on the screen is installed in a menu.

With the selection of an “associated folder search” in this menu, an application using the present invention is invoked.

The application using the present invention, which is invoked with the above described menu, is described next.

The application searches folders managed by the system for a folder associated with the selected folder. When the search is successfully terminated, a folder graph described in the first embodiment is determined.

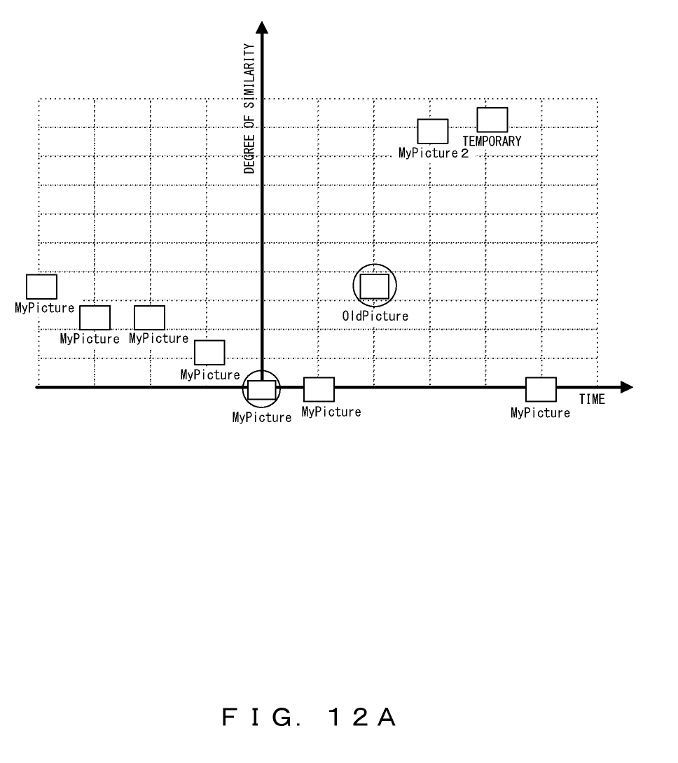

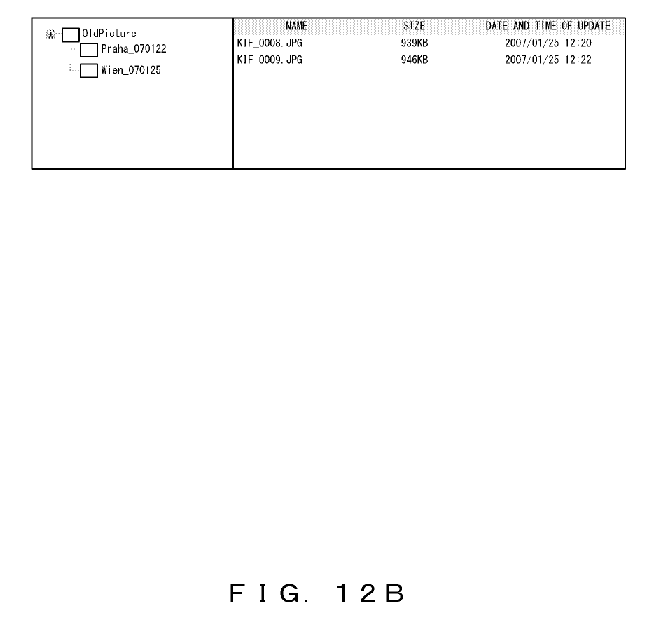

Next, the folder graph is displayed as shown in FIGS. 12A and 12B. For example, the folder graph is mapped on an XY graph and displayed. FIG. 12A shows the graph with its horizontal axis (assumed to be the X axis) and vertical axis (assumed to be the Y axis) that respectively indicate time and a distance between folders.

The folder to be searched is placed at the origin point (the circled folder in FIG. 12A), and the other folders within the folder graph are placed and displayed at corresponding positions in the graph. Additionally, the names of the folders are respectively displayed under the icons of the folders.

The value of the X axis is determined based on the time when each of the folders is generated by being copied. Since a plurality of folders are never generated simultaneously as is known from the way of generating a folder graph, the value of the X axis differs for all of the folders within the folder graph. The value of the X axis itself does not have special meaning, and only indicates temporal order.

The value of the Y axis is determined based on the results of calculating the degree of similarity to the folder to be searched, which is placed at the origin point. If a folder has exactly the same contents as those of the folder to be searched, its distance becomes “0”. Therefore, this folder is placed on the X axis.

By displaying folders in this way, the degree of similarity between each of the folders and the folder to be searched can be intuitively learned.

Namely, for example, the folder at the rightmost position on the X axis is the newest one in terms of time, and the folder at the topmost position on the Y axis has the lowest degree of similarity to the folder to be searched.

Additionally, the folders on the X axis are exactly identical to the folder to be searched. This also proves that the folder to be searched can be deleted without considering a lot if such folders are found in the same storage device.

Note that distances between the folders except for the folder to be searched are not learned from this graph. Taking a simple example, even two folders having the same value of the Y axis within the graph cannot be determined to be exactly identical folders. The reason is described below based on the assumption that there are two folders A and B respectively including files only one of which is different from those of the folder to be searched. In this case, the distance between the folder A and the folder to be searched and the distance between the folder B and the folder to be searched can be possibly determined to be identical although this depends on a calculation method. However, the file in the folder A, which is different from the folder to be searched, and the file in the folder B, which is different from the folder to be searched, are not always identical.

(Display of Details of a Difference)

When each folder within the graph region is selected, its details are displayed in a details display region. FIG. 12B shows an example where the clicked folder is the circled folder (Oldpicture), and its details are displayed below the graph screen. With the display of details, for example, files or folders included in each folder are displayed by using a tree structure. At this time, a file or folder, which is different from the folder to be searched, is displayed in a different color (or its shape may be changed). In FIG. 12B, a file “KIF_{—}0008.JPG” within a folder “Wien_{—}070125” is different from the files within the folder to be searched. Therefore, its characters may be displayed, for example, in red color.

By displaying the folders or files in this way, a difference between each of the folders and the folder to be searched can be intuitively learned.

Alternatively, contents of a difference may be made visible by displaying a menu entry of “display a difference” when a file or folder detected to be different is selected, and by selecting the menu entry, although this is not shown in FIG. 12B.

When “Wien_{—}070125” is selected and then “display a difference” is selected, for example, a message such that “KIF_{—}0008.JPG in this folder differs” is displayed. If a plurality of files are different, their names may be displayed as a list. By right-clicking on “KIF_{—}0008.JPG” to select “display a difference” for example, a message such that “file size differs” is displayed. If a different file is a text file, contents resultant from a comparison may be displayed.

(Display Change in a Folder Tree).

In the above described graph, each of the folders displayed in the graph can be also placed at the origin point and redisplayed. This is implemented by performing, for example, an operation for selecting and double-clicking a folder.

At the time point when this operation is performed, the folder graph is redisplayed by recognizing the selected folder as a folder to be searched.

This display change is an essential display method because of the nature such that a folder except for a folder placed at the origin point cannot be determined to have the same contents as other file's contents even if they have the same value of the Y axis. Folders having the same value of the Y axis are expected to have identical or nearly identical contents. Therefore, one of the folders is redisplayed as the folder placed at the origin point, whether or not the folders are identical can be definitely determined.

As described above, files are collectively managed in units of folders to which the files belong. As a result, even if many files scatter in a plurality of storage regions, it becomes easier to search a redundant or a partially matching file group.

If there are a plurality of folders including many files, some of which are different, folders including files the contents of which are close to those of a specified folder can be sequentially searched.

The degrees of similarity among a plurality of folders having similar contents are displayed to make a user intuitively learn the degrees with ease, whereby a required file can be easily found.

Additionally, if files managed by this system are video image data, audio data, or still images, the utility values of these data become higher as their image or audio quality becomes better, and data with high image or audio quality are seemingly desired to be obtained first as search results. Therefore, the search results may be arranged in descending order of the amount of information.

Assume that an MP3 file is generated from a music album CD, data of low sound quality is generated on one day, and data of higher sound quality is generated later. In this case, which of the data has high sound quality may be displayed.

Also assume that a TV program is initially recorded with low image quality because of the insufficient capacity of a hard disk, and then recorded with high image quality after expanding the hard disk when the program is rebroadcast. In this case, the program recorded with high image quality may be searched earlier.

According to the present invention, the control processes represented by the flowcharts in the above described embodiments can be carried out by causing a computer to execute a program that describes instructions to perform the control processes.

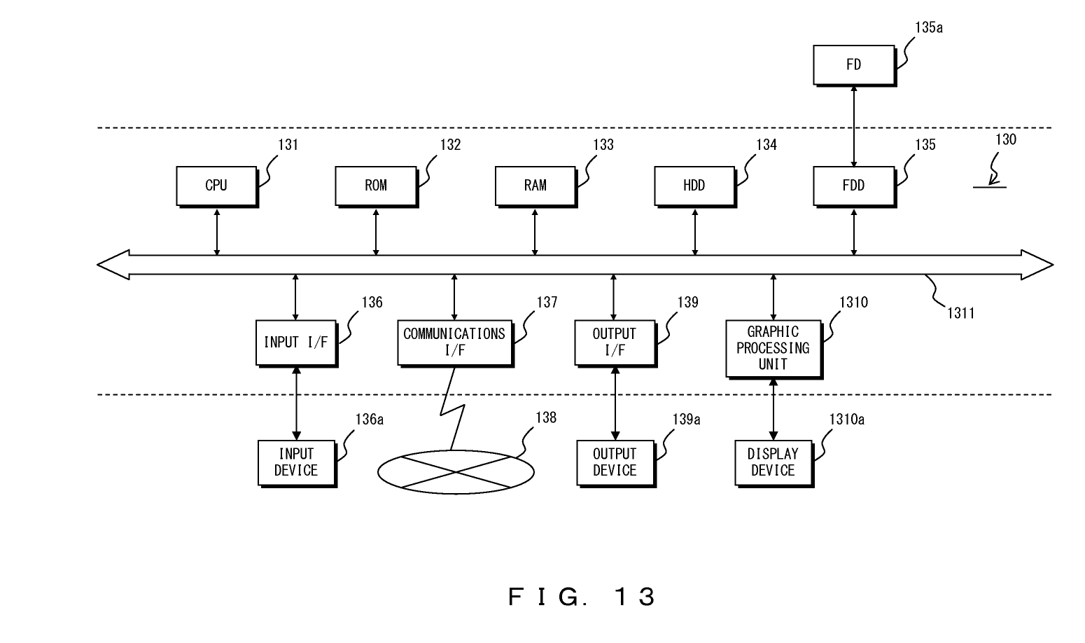

FIG. 13 is a block diagram showing a system configuration for carrying out the present invention. In this figure, a computer 130 includes a CPU 131, a ROM 132, a RAM 133, a hard disk drive (HDD) 134, a flexible disk drive (FDD) 135, an input interface (input I/F) 136, a communications interface (communications I/F) 137, an output interface (output I/F) 139, a graphic processing unit 1310, and the like. These constituent elements are interconnected by a bus 1311.

The CPU 131 executes a process according to a program and data, which are stored in the ROM 132, the RAM 133, the HDD 134, or the FDD 135, and controls the whole of the computer 130. The ROM 132 records a basic program (boot program, etc.) executed by the CPU 131, and data. The RAM 133 records a program or data while the CPU 131 is executing the program, and is used as a working area, etc.

The HDD 134, in which an OS (Operating System), an application program, etc. executed by the CPU 131 are recorded, makes a data read/write from/to the hard disk under the control of the CPU 131. The FDD 135 controls a data read/write from/to an FD 135a under the control of the CPU 131. Data written under the control of the FDD 135 is stored on the FD 135a, or data stored on the FD 135a is read by the computer 130. In addition to the FD 135a, computer-readable recording media such as a magnetic recording device, an optical disc, a magneto-optical recording medium, a semiconductor memory, etc. are available as insertable/removable recording media. The magnetic recording device is a hard disk device (HDD), a flexible disk (FD), a magnetic tape, etc. The optical disc is a DVD (Digital Versatile Disc), a DVD-RAM (Random Access Memory), a CD-ROM (Compact Disc Read Only Memory), a CD-R (Recordable)/RW (ReWritable), etc. The magneto-optical recording medium is an MO (Magneto-Optical disk), etc.

The input I/F 136, to which a mouse or a keyboard is connected, receives information input by a user, and transmits the information to the CPU 131 via the bus 1311. The input device 136a may be a touch-panel input pad, a ten key, etc. The mouse moves a cursor, selects a range, moves a window, changes a size of the window, and the like. A trackball, a joystick, etc. may be available as far as it has a similar function as a pointing device.

The communications I/F 137 is an interface for making a LAN connection to another computer, an Internet connection, or a wireless connection. The communications I/F 137 makes a connection to another device via a network such as the Internet through a communications line. A network 138 and the internal interface control a data input/output from/to an external device. For example, a modem, a LAN adapter, etc. can be adopted.

The output I/F 139 is provided to control an output device 139a such as a printer, etc. The graphic processing unit 1310, to which a display device 1310a such as a display unit, etc. is connected, displays operation information, a log after a logic simulation, the total sum of coverage, a signal waveform, etc. on the screen of the display device 1310a in accordance with a drawing instruction issued from the CPU 131. For example, a CRT, a TFT liquid crystal display, a plasma display, etc. can be adopted. The display device may be connected to the output I/F 139 not via the graphic processing unit 1310.

By using one or more computers each having such a hardware configuration, the above described various types of processing functions are carried out. In this case, a program that describes the contents of the processing functions, which are possessed by the system, is provided. The computer executes the program, whereby the above described processing functions are carried out on the computer. The program that describes the contents of the processing functions can be recorded on a computer-readable recording medium.

When the program is distributed, for example, a portable recording medium such as a DVD, a CD-ROM, etc. on which the program is recorded is marketed. Alternatively, the program can be stored in a storage device of a server computer, and transferred from the server computer to another computer via a network.

The computer that executes the program stores the program in its storage device, for example, recorded on the portable recording medium or transferred from the server computer. Then, the computer reads the program from its storage device, and executes the processes according to the program. The computer can directly read the program from the portable recording medium, and execute the processes according to the program. Alternatively, the computer can sequentially execute a process according to a received program each time the program is transferred form the server computer.

The program is stored on a recording medium such as a CD-ROM, etc., whereby the control processes can be carried out by installing the program in the computer. Alternatively, the program may be downloaded into the computer via a communications network.

The present invention is not limited to the above described embodiments, and can be improved and modified within a scope that does not depart from the gist of the present invention.

The following claims are disclosed for the above described embodiments.

What is claimed is:

1. An electronic file managing apparatus for managing files or folders, comprising:
a file change detecting unit for detecting that a file or folder is copied to a location manageable by the electronic file managing apparatus, and that the copied file or folder is changed; and
a virtual folder managing unit for managing the copied or changed file or folder and a copy or change source file or folder as virtual folders by making an association between the copied or changed file or folder and the copy or change source file or folder.

2. The electronic file managing apparatus according to claim 1, wherein
the virtual folder managing unit manages a copy destination virtual folder as a child of a copy source virtual folder by using a tree structure, when the file change detecting unit detects that a file or folder, which is not managed as the virtual folder, is copied, and
the virtual folder managing unit newly generates a child virtual folder by using an already existing virtual folder as a parent, and manages the child virtual folder by using a tree structure, when the file change detecting unit detects that a file or folder, which is managed as the virtual folder, is copied.

3. The electronic file managing apparatus according to claim 2, wherein
when the virtual folder managing unit manages a virtual folder, a time when the virtual folder is generated, and information of a calculated distance from the virtual folder to a root virtual folder are held.

4. The electronic file managing apparatus according to claim 3, wherein
the virtual folder managing unit causes a distance to a root folder recorded for a virtual folder to be recalculated if a file or folder is added, some files or folders are deleted, or a file or folder is renamed or edited within the managed virtual folder, and
the virtual folder managing unit deletes management information of the virtual folder, and reconnects all of child virtual folders to a parent of the deleted virtual folder, if all of files or folders included in the managed virtual folder are deleted.

5. The electronic file managing apparatus according to claim 4, wherein:
a flag indicating that a virtual folder is recorded in a removable external storage device is set when a file or folder of the virtual folder is copied to the removable external storage device;
an external storage node flag indicating a node of an external storage device is set for the virtual folder in a storage region, which is not removable from the electronic file managing apparatus; and
an external storage removal flag indicating that the external storage device is removed is set for the virtual folder recorded in the external storage device, when the external storage device is detected to be removed.

6. The electronic file managing apparatus according to claim 1, wherein:
similar folders are searched by using a folder name recorded in management information managed by the virtual folder managing unit as a key, when similar files or folders are searched by specifying a file or folder; and
a distance of a virtual folder managed by the virtual folder managing unit is calculated, and results of a similar folder search are output in ascending order of the calculated distance.

7. The electronic file managing apparatus according to claim 2, further comprising:
an external storage connection detecting unit for detecting that the external storage device is connected to the electronic file managing apparatus; and
an external storage sameness determining unit for searching for an external storage removal flag, and for determining whether or not the connected external storage device matches a previously managed external storage device when a virtual folder with its flag validated is found, wherein
when the external storage device determined not to be previously managed is connected to the electronic file managing apparatus, virtual folders with their external storage node flag validated are listed, a distance between a file or folder recorded in a specified external storage device and all of virtual folders with their external storage node flag validated is calculated when a virtual folder with the flag validated is detected, and the external storage sameness determining unit determines a virtual folder having a shortest distance, and
the determined virtual folder and child virtual folders of the determined virtual folder are output, as search results, in ascending order of the distance to the external storage device.

8. The electronic file managing apparatus according to claim 6, wherein
a folder to be searched and results of the search are displayed by using the folder to be searched as a base point.

9. An electronic file managing method for managing files or folders, comprising:
detecting that a file or folder is copied to a location manageable by an electronic file managing apparatus, and that the copied file or folder is changed; and
managing the copied or changed file or folder and a copy or change source file or folder as virtual folders by making an association between the copied or changed file or folder and the copy or change source file or folder.

10. A computer-readable recording medium on which is recorded a program for causing a computer to execute an electronic file managing process for managing files or folders, the process comprising:
detecting that a file or folder is copied to a location manageable by an electronic file managing apparatus, and that the copied file or folder is changed; and
managing the copied or changed file or folder and a copy or change source file or folder as virtual folders by making an association between the copied or changed file or folder and the copy or change source file or folder.

11. The electronic file managing apparatus according to claim 3, wherein
the distance to the root virtual folder is calculated based on a difference between the numbers of files included in folders.

12. The electronic file managing apparatus according to claim 3, wherein
the distance to the root virtual folder is calculated based on a difference between total sums of sizes of files included in folders.

13. The electronic file managing apparatus according to claim 3, wherein
the distance to the root virtual folder is calculated based on a difference between total sums of lengths of names of files included in folders.

14. The electronic file managing apparatus according to claim 8, wherein
the folder to be searched and the results of the search are displayed by using one axis as time, and the other axis as a distance between folders.

15. The electronic file managing apparatus according to claim 8, wherein
when each displayed folder is selected, details of the selected folder are displayed.

16. The electronic file managing apparatus according to claim 15, wherein
a name of a different file is displayed in a different color when details are displayed.

17. The electronic file managing apparatus according to claim 8, wherein
an icon that is displayed by being attached to a file is changed for a different file, when details of the different file are displayed.

18. The electronic file managing apparatus according to claim 8, wherein
a menu for displaying a difference is displayed, when each displayed folder is selected.

19. The electronic file managing apparatus according to claim 6, wherein
an amount of information within a virtual folder is calculated, and results of a similar folder search are sequentially output in descending order of the amount of information.

20. The electronic file managing apparatus according to claim 19, wherein
the amount of information is calculated based on a bit rate of a video image file within a virtual folder, based on a screen resolution of a video image file within a virtual folder, based on a bit rate of an audio file within a virtual folder, based on a sampling rate of an audio file within a virtual folder, or based on an image quality of a still image file within a virtual folder.
